(19) United States
(12) Patent Application Publication
(10) Pub. No.: US 2013/0158161 A1
(43) Pub. Date: Jun. 20, 2013

(54) Polycarbonate Resin Composition with Mar Resistance and Scratch Resistance

(71) Applicant: Cheil Industries Inc., Kumi-city (KR)

(72) Inventors: In Chol KIM, Seoul-si (KR); Jin Uk HA, Uiwang-si (KR); Chang Min HONG, Uiwang-si (KR); Jeung Min LEE, Seoul-si (KR)

(73) Assignee: CHEIL INDUSTRIES INC., Kumi-city (KR)

(21) Appl. No.: 13/709,109

(22) Filed: Dec. 10, 2012

(30) Foreign Application Priority Data
Dec. 19, 2011 (KR) 10-2011-0137171

(51) Int. Cl. C08L 69/00

(52) U.S. Cl. 523/122; 525/72; 524/504

(57) ABSTRACT

A polycarbonate resin composition includes 100 parts by weight of a base resin composition including about 30 to about 50 wt. % of a polycarbonate resin (A), about 20 to about 40 wt. % of a modified acrylic copolymer (B), about 5 to about 10 wt. % of a rubber modified aromatic vinyl graft copolymer (C), and about 10 to about 30 wt % of polybutylene terephthalate resin (D); and about 1 to about 8 parts by weight of a siloxane-co-polyester (E).

### CROSS-REFERENCE TO RELATED APPLICATION

This application claims priority under 35 USC Section 119 to and the benefit of Korea Patent Application No. 10-2011-0137171 filed Dec. 19, 2011, in the Korean Intellectual Property Office, the disclosure of which is incorporated herein by reference in its entirety.

### FIELD OF INVENTION

This invention relates to a thermoplastic resin composition that can have excellent mar resistance and scratch resistance.

### BACKGROUND OF INVENTION

There is ongoing research directed to making the appearance of materials for housings used in various products such as electric/electronics product, home appliances, office automation equipment, mobile phones, automobiles, and the like more sophisticated and beautiful. Of particular interest are high gloss materials. However, it can be difficult to provide these properties using only a synthetic resin, and thus most prior attempts have used coatings on the surface of the materials.

However, there can be many disadvantages of coating the surface of the material. Coating processes can include a series of process steps, such as bottom coating, base coating, and top coating, and the defect rates generated during these processes can be quite high, which can increase costs and waste (because the defective items cannot be recycled). In addition, there can be environmental concerns associated with coating processes. For example, one exemplary coating process is a carbon dioxide generation process, which generates toxic volatile components in large quantities.

Due to the problems associated with the coating process as mentioned above, there is a need for materials which can be used in various product parts without applying any coating. However, there has been limited success developing materials which can satisfy different physical property requirements, such a color realization (colorability), scratch resistance, and impact resistance.

For example, scratch resistance and impact resistance can be contradictory properties of a synthetic resin material. Accordingly, typically if one of these physical properties is improved, the other property can be impaired. Moreover, if a reinforcing agent is used, although the scratch resistance can improve, the resin can have decreased dyeability or colorability.

### SUMMARY OF INVENTION

The present invention is directed to a polycarbonate resin composition that can have improved dyeability, impact resistance, scratch resistance, and/or mar resistance without requiring a coating.

A polycarbonate resin composition in accordance with this invention includes (A) polycarbonate resin; (B) modified acrylic copolymer; (C) rubber modified aromatic vinyl graft copolymer; (D) polybutylene terephthalate resin; and (E) siloxane-co-polyester.

In exemplary embodiments, the polycarbonate resin composition can include about 1 to about 8 parts by weight siloxane-co-polyester (E), based on about 100 parts by weight of a base resin composition including about 30 to about 50 wt. % of polycarbonate resin (A); about 20 to about 40 wt. % of modified acrylic copolymer (B); about 5 to about 10 wt. % of rubber modified aromatic vinyl graft copolymer (C); and about 10 to about 30% of polybutylene terephthalate resin (D).

The modified acrylic copolymer (B) can have a refractive index of about 1.495 to about 1.590 and a weight average molecular weight of about 5,000 g/mol to about 50,000 g/mol.

A polycarbonate resin composition in accordance with this invention can have excellent impact strength, for example, can have a notched Izod impact strength (⅛″) of about 10 kgf·cm/cm to about 65 kgf·cm/cm measured in accordance with the method specified in ASTM D256. Also, a polycarbonate resin composition according to this invention can have excellent heat resistance, for example can have a heat deflection temperature (HDT) higher than about 100° C. measured in accordance with ASTM D648. The mar resistance of polycarbonate resin composition in this invention can also be excellent, for example, the composition can have a ΔGloss (20°) of less than about 15 measured using a gloss meter (M23888 from SDL ATLAS) in accordance with ASTM D523 after rubbing a 8×15 sized specimen ten times with a white cotton cloth. A polycarbonate resin composition according to the invention can also have excellent scratch resistance, for example, can have a pencil hardness higher than F grade when measured under a load 500 g in accordance with JIS K5401.

### DETAILED DESCRIPTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

A polycarbonate resin composition of the present invention includes (A) polycarbonate resin; (B) modified acrylic copolymer; (C) rubber modified aromatic vinyl graft copolymer; (D) polybutylene terephthalate resin; and (E) siloxane-co-polyester.

(A) Polycarbonate Resin

The type of polycarbonate resin is not limited in this invention. Examples of polycarbonate resins that can be used in the present invention include without limitation aliphatic polycarbonate resins, aromatic polycarbonate resins, copolycarbonate resins, copolyestercarbonate resins, polycarbonate-polysiloxane copolymers, and the like, and combinations thereof. Also, the polycarbonate resin can have a linear or branched structure.

Exemplary polycarbonate resins useful in the present invention can be prepared by reacting (a1) an aromatic dihydroxy compound and (a2) a carbonate precursor.

(a1) Aromatic Dihydroxy Compound

Exemplary aromatic dihydroxy compounds (a1) include without limitation compounds represented by Chemical Formula 1 below:

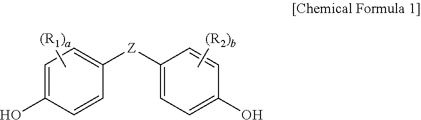

In Chemical Formula 1, R₁ and R₂ are the same or different and are each independently hydrogen, halogen, or C1 to C8 alkyl; a and b are the same or different and are each independently an integer of 0 to 4, and Z is a single bond, C1 to C8 alkylene, C2 to C8 alkylidene, C5 to C15 cycloalkylene, —S—, —SO—, SO₂, —O—, or —CO—.

Examples of aromatic dihydroxy compounds represented by Chemical Formula 1 include without limitation bis(hydroxyl aryl) alkanes such as bis(4-hydroxyphenyl)methane, bis(3-methyl-4-hydroxyphenyl)methane, bis(3-chloro-4-hydroxyphenyl)methane, bis(3,5-dibromo-4-hydroxyphenyl)methane, 1,1-bis(4-hydroxyphenyl)ethane, 1,1-bis(2-tertiary-butyl-4-hydroxy-3-methylphenyl)ethane, 2,2-bis(4-hydroxyphenyl)propane (bisphenol A), 2,2-bis(3-methyl-4-hydroxyphenyl)propane, 2,2-bis(2-methyl-4-hydroxyphenyl)propane, 2,2-bis(3,5-dimethyl-4-hydroxyphenyl)propane, 1,1-bis(2-tertiary-butyl-4-hydroxy-5-methyl phenyl)propane, 2,2-bis(3-chloro-4-hydroxyphenyl)propane, 2,2-bis(3-fluoro-4-hydroxy phenyl)propane, 2,2-bis(3-bromo-4-hydroxyphenyl)propane, 2,2-bis(3,5-difluoro-4-hydroxy phenyl)propane, 2,2-bis(3,5-dichloro-4-hydroxyphenyl)propane, 2,2-bis(3,5-dibromo-4-hydroxyphenyl)propane, 2,2,-bis(4-hydroxyphenyl)butane, 2,2-bis(4-hydroxyphenyl)octane, 2,2-bis(4-hydroxyphenyl)phenyl methane, 2,2-bis(4-hydroxy-1-methylphenyl)propane, 1,1-bis(4-hydroxy-tertiary-butyl phenyl)propane, 2,2-bis(4-hydroxy-3-bromo phenyl)propane, 2,2-bis(4-hydroxy-3,5-dimethylphenyl)propane, 2,2-bis(4-hydroxy-3,5-dimethyl phenyl)propane, 2,2-bis(4-hydroxy-3-chlorophenyl)propane, 2,2-bis(4-hydroxy-3,5-dichloro phenyl)propane, 2,2-bis(4-hydroxy-3,5-dibromophenyl)propane, 2,2-bis(4-hydroxy-3,5-dibromo phenyl)propane, 2,2-bis(3-bromo-4-hydroxy-5-chloro phenyl)propane, 2,2-bis(3-phenyl-4-hydroxyphenyl)propane, 2,2-bis(4-hydroxyphenyl)butane, 2,2-bis(3-methyl-4-hydroxyphenyl)butane, 1,1-bis(2-butyl-4-hydroxy-5-methylphenyl)butane, 1,1-bis(2-tertiary-butyl-4-hydroxy-5-methylphenyl)butane, 1,1-bis(2-tertiary-butyl-4-hydroxy-5-methylphenyl)isobutane, 1,1-bis(2-tertiary-amyl-4-hydroxy-5-methylphenyl)butane, 2,2-bis(3,5-dichloro-4-hydroxyphenyl)butane, 2,2-bis(3,5-dibromo-4-hydrophenyl)butane, 4,4-bis(4-hydroxyphenyl)heptane, 1,1-bis(2-tertiary-butyl-4-hydroxy-5-methyl phenyl)heptane, 2,2-bis(4-hydroxyphenyl)octane, 1,1-(4-hydroxyphenyl)ethane, and the like; bis(hydroxyl aryl)cycloalkanes such as 1,1-bis(4-hydroxyphenyl)cyclopentane, 1,1-bis(4-hydroxyphenyl)cyclohexane, 1,1-bis(3-methyl-4-hydroxyphenyl)cyclohexane, 1,1-bis(3-cyclohexyl-4-hydroxyphenyl)cyclohexane, 1,1-bis(3-phenyl-4-hydroxyphenyl)cyclohexane, 1,1-bis(4-hydroxyphenyl)-3,5,5-trimethylcyclohexane, and the like; bis(hydroxyl aryl)ethers, such as bis(4-hydroxyphenyl)ether, bis(4-hydroxy-3-methylphenyl)ether, and the like; bis(hydroxyl aryl)sulfides such as bis(4-hydroxylphenyl)sulfide, bis(3-methyl-4-hydroxy phenyl)sulfide, and the like: bis(hydroxylaryl)sulfoxides such as bis(hydroxyl phenyl)sulfoxide, bis(3-methyl-4-hydroxyphenyl)sufoxide, bis(3-phenyl-4-hydroxy phenyl)sulfoxide, and the like; biphenyl compounds such as bis(hydroxyl aryl)sulfones such as bis(4-hydroxyphenyl)sulfone, bis(3-methyl-4-hydroxyphenyl)sulfone, bis(3-phenyl-4-hydroxyphenyl)sulfone, and the like, 4,4′-dihydroxy biphenyl, 4,4′-dihydroxy-3,3′dicyclobiphenyl, 3,3-difluoro-4,4′-dihydroxy biphenyl, and the like, and combinations thereof. These compounds can be used singly or as a combination of two or more compounds.

Examples of other aromatic dihydroxy compounds which can be used other than or in addition to the compounds represented by Chemical Formula 1 include without limitation dihydroxy benzene, halogen or C1-C10 alkyl substituted dihydroxy benzene, and the like, and combinations thereof, such as resorcinol, 3-methylresorcinol, 3-ethylresorcinol, 3-propyresorcinol, 3-butylresorcinol, 3-tertiary-butylresorcinol, 3-phenylresorcinol, 2,3,4,6-tetrafluororesorcinol, 2,3,4,6-tetrabromoresorcinol, catechol, hydroquinone, 3-methylhydroquinone, 3-ethylhydroquinone, 3-propylhydroquinone, 3-butylhydroquinone, 3-tertiary-butylhydroquinone, 3-phenylhydroquinone, 3-cumylhydroquinone, 2,5-dichlorohydroquinone, 2,3,5,6-tetramethylhydroquinone, 2,3,5,6-tetra-tertiary-butylhydroquinone, 2,3,5,6-tetrafluorohydroquinone, 2,35,6-tetrabromohydroquinone, and the like, and combinations thereof.

In exemplary embodiments 2,2-bis(4-hydroxyphenyl)propane (bisphenol A) can be used as an aromatic dihydroxy compound.

(a2) Carbonate Precursors

Examples of carbonate precursors that can be used in the present invention include without limitation dimethyl carbonate, diethyl carbonate, dibutyl carbonate, dicyclohexyl carbonate, diphenyl carbonate, ditolyl carbonate, bis(chlorophenyl)carbonate, m-cresyl carbonate, dinaphtyl carbonate, bis(diphenyl)carbonate, carbonyl chloride (phosgene), triphosgene, diphosgene, carbonyl bromide, bishaloformate, and the like, and combinations thereof. These compounds can be used singly or as a combination of two or more compounds.

In exemplary embodiments, carbonyl chloride (phosgene) can be used in interfacial polymerization.

The carbonate precursors can be used in a mole ratio of about 0.9 to about 1.5 mole per about 1 mole of aromatic dihydroxy compound.

In exemplary embodiments, the polycarbonate resin (A) can have a weight average molecular weight of about 10,000 g/mol to about 200,000 g/mol, for example about 15,000 to about 80,000 g/mol.

In exemplary embodiments, the polycarbonate resin (A) can have a melt flow index of about 3 g/10 min. to about 120 g/10 min. at a temperature about 310° C. under a load of about 1.2 kg.

The polycarbonate resin composition can include the polycarbonate resin (A) in an amount of about 30 to about 50 wt. %, based on about 100 wt. % of a base resin composition including the components (A)+(B)+(C)+(D) as defined herein. In some embodiments, the polycarbonate resin composition can include the polycarbonate resin (A) in an amount of about 30, 31, 32, 33, 34, 35, 36, 37, 38, 39, 40, 41, 42, 43, 44, 45, 46, 47, 48, 49, or 50 wt. %. Further, according to some embodiments of the present invention, the amount of the polycarbonate resin (A) can be in a range from about any of the foregoing amounts to about any other of the foregoing amounts.

If polycarbonate resin composition includes the polycarbonate resin in an amount within the above range, the composition can have excellent dyeability, impact resistance, and scratch resistance.

(B) Modified Acrylic Copolymer Resin

In this invention, the modified acrylic copolymer resin (B) can help improve dyeability and scratch resistance of the polycarbonate resin composition.

The modified acrylic copolymer resin (B) includes a unit derived from an acrylate or methacrylate including an aliphatic cyclic hydrocarbon group or an aromatic hydrocarbon group. Examples of the aliphatic cyclic hydrocarbon group include without limitation C3 to C30 cycloalkyl, C3 to C20 cycloalkenyl and C3 to C30 cycloalkynyl. Examples of the aromatic hydrocarbon group include without limitation C6 to C30 aryl.

The aliphatic cyclic hydrocarbon group or aromatic hydrocarbon group can be substituted with one or more C1 to C10 linear or branched alkyl, C3 to C10 cyclic alkyl, C1 to C10 linear or branched alkoxy, C3 to C10 cyclic alkoxy, C1 to C10 linear or branched alkylthio, C3 to C10 cyclic alkylthio, C1 to C10 linear or branched alkylamine, C3 to C10 cyclic alkylamine, C6 to C18 aryl, C6 to C18 aryloxy, C6 to C18 arylthio, C6 to C18 arylamine, halogen, and the like, and combinations thereof.

The aliphatic cyclic hydrocarbon or aromatic hydrocarbon can be bonded directly to an acrylate or methacrylate group, or can be bonded to the acrylate or methacrylate group via a bridging group. Examples of the bridging group include without limitation C1 to C10 alkylene, C2 to C10 alkylidene, C5 to C15 cycloalkylene, C5 to C15 cycloalkylidene, —S—, —SO—, SO₂—, —CO—, and the like, and combinations thereof.

The modified acrylic copolymer resin (B) in this invention can be made by polymerization of (b1) acrylate or methacrylate compound which includes an aliphatic cyclic hydrocarbon group or an aromatic hydrocarbon groups and (b2) mono-functional unsaturated monomers. As used herein, the term mono-functional unsaturated monomers (b2) refers to compounds having an unsaturated group. The mono-functional unsaturated monomers are also different from the (b1) acrylate or methacrylate compound which contains the aliphatic cyclic hydrocarbon group or aromatic hydrocarbon group.

The modified acrylic copolymer resin can include the acrylate or methacrylate (b1) including the aliphatic cyclic hydrocarbon group or aromatic hydrocarbon group in an amount of about 5 wt % to about 95 wt. %, based on the total weight of the modified acrylic copolymer resin. In some embodiments, the modified acrylic copolymer resin can include the acrylate or methacrylate (b1) in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 wt. %. Further, according to some embodiments of the present invention, the amount of the acrylate or methacrylate (b1) can be in a range from about any of the foregoing amounts to about any other of the foregoing amounts.

The modified acrylic copolymer resin can include the mono-functional unsaturated monomer (b2) in an amount of about 5 wt. % to about 95 wt. %, based on the total weight of the modified acrylic copolymer resin. In some embodiments, the modified acrylic copolymer resin can include the mono-functional unsaturated monomer (b2) in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 wt. %. Further, according to some embodiments of the present invention, the amount of the mono-functional unsaturated monomer (b2) can be in a range from about any of the foregoing amounts to about any other of the foregoing amounts.

Examples of the acrylate or methacrylate compounds (b1) including an aliphatic cyclic hydrocarbon group or aromatic hydrocarbon group include compounds represented by the following Chemical Formula 2, Chemical Formula 3, and combinations thereof:

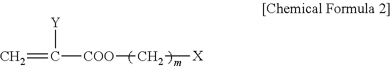

In the above Chemical Formula 2, m is an integer of 0 to 10; X is C3 to C30 cycloalkyl, C3 to C30 cycloalkenyl, C3 to C30 cycloalkynyl group, or C6 to C30 aryl group; and Y is hydrogen or methyl;

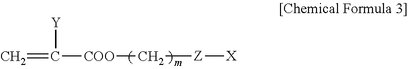

In the above Chemical Formula 3, m is an integer of 0 to 10; X is C3 to C30 cycloalkyl, C3 to C30 cycloalkenyl, C3 to C30 cycloalkynyl, or C6 to C30 aryl; Y is 20 hydrogen or methyl; and Z is O or S.

Examples of the acrylate or methacrylate compounds (b1) including the above aliphatic cyclic hydrocarbon group or aromatic hydrocarbon group include without limitation cyclohexyl acrylate, cyclohexyl methacrylate, ethylphenoxy acrylate, ethylphenoxy methacrylate, 2-ethylthiophenyl acrylate, 2-ethylthiophenyl methacrylate, 2-ethylaminophenyl acrylate, 2-ethylaminophenyl methacrylate, phenyl acrylate, phenyl methacryate, benzyl acrylate, benzyl methacrylate, 2-phenylethyl acrylate, 2-phenylethyl methacrylate, 3-phenylpropyl acrylate, 3-phenylpropyl methacrylate, 4-phenylbutyl acrylate, 4-phenylbutyl methacrylate, 2-2-methylphenylethyl acrylate, 2-2-methylphenylethyl methacrylate, 2-3-methylphenylethyl acrylate, 2-3-methylphenylethyl methacrylate, 2,4-methylphenylethyl acrylate, 2,4-methylphenylethyl methacrylate, 2-(4-propylphenyl)ethyl acrylate, 2-(4-propylphenyl)ethyl methacrylate, 2-(4-(1-methylethyl)phenyl)ethyl acrylate, 2-(4-(1-methylethyl)phenyl)ethyl methacrylate, 2-(4-methoxyphenyl)ethyl acrylate, 2-(4-methoxyphenyl)ethyl methacrylate, 2-(4-cyclohexylphenyl)ethyl acrylate, 2-(4-cyclohexylphenyl)ethyl methacrylate, 2-(2-chlorophenyl)ethyl acrylate, 2-(2-chlorophenyl)ethyl methacrylate, 2-(3-chlorophenyl)ethyl acrylate, 2-(3-chlorophenyl)ethyl methacrylate, 2-(4-chlorophenyl)ethyl acrylate, 2-(4-chlorophenyl)ethyl methacrylate, 2-(4-bromophenyl)ethyl acrylate, 2-(4-bromophenyl)ethyl methacrylate, 2-(3-phenylphenyl)ethyl acrylate, 2-(3-phenylphenyl)ethyl methacrylate, 2-(4-benzylphenyl)ethyl acrylate, 2-(4-benzylphenyl)ethyl methacrylate, and the like, and combinations thereof.

Examples of the mono-functional unsaturated monomer (b2) include without limitation acrylates or methacrylates including an aliphatic non-cyclic hydrocarbon group, unsaturated carboxylic acids, unsaturated carboxylic anhydrides, unsaturated monomers including an hydroxy group, unsaturated monomers including an epoxy group, unsaturated amide monomers, unsaturated imide monomers, unsaturated nitrile monomers, aromatic vinyl monomers, and the like, and combinations thereof.

Examples of acrylates or methacrylates including an aliphatic non-cyclic hydrocarbon group include without limitation methyl acrylate, methyl methacrylate, ethyl acrylate, ethyl methacrylate, propyl acrylate, propyl methacrylate, butyl acrylate, butyl methacrylate, and the like, and combinations thereof. As used herein, the term aliphatic non-cyclic hydrocarbon group includes C1 to C20 aliphatic non-cyclic hydrocarbon groups, such as C1 to C20 alkyl groups.

Examples of unsaturated carboxylic acids include without limitation acrylic acid, methacrylic acid, and the like, and combinations thereof.

Example of unsaturated carboxylic acid anhydrides include without limitation maleic acid anhydride and the like, and combinations thereof.

Examples of unsaturated monomers including an hydroxyl group include without limitation 2-hydroxyethyl acrylate, 2-hydroxyethyl methacrylate, 2-hydroxypropyl acrylate, 2-hydroxypropyl methacrylate, monoglycerol acrylate, monoglycerol methacrylate, and the like, and combinations thereof.

Examples of unsaturated monomers including an epoxy group include without limitation allyl glycidyl ether, glycidyl acrylate, glycidyl methacrylate, and the like, and combinations thereof.

Examples of unsaturated amide monomers include without limitation acrylamide, methacrylamide, and the like, and combinations thereof.

Examples of imide monomers include without limitation maleimides and combinations thereof.

Examples of unsaturated nitrile monomers include without limitation acrylonitrile, methacrylonitrile, ethacrylonitrile, and the like, and combinations thereof.

Examples of aromatic vinyl monomers include without limitation styrene, C1 to C10 alkyl substituted styrene, halogen substituted styrene, vinyl naphthalene, and the like, and combinations thereof. As used herein, C1 to C10 alkyl substituted styrene includes styrene in which a hydrogen atom of the benzene ring or the vinyl group is substituted with C1 to C10 alkyl, and the term halogen substituted styrene includes styrene in which a hydrogen atom of the benzene ring or the vinyl group is substituted with halogen.

The refractive index of the modified acrylic copolymer resin (B) can range from about 1.495 to about 1.590. When the modified acrylic copolymer resin (B) has a refractive index within the above range, compatibility thereof with the polycarbonate resin can be improved, and the polycarbonate resin composition can have excellent transparency and dyeability.

The modified acrylic copolymer (B) can have a weight average molecular weight of about 5,000 g/mol to about 50,000 g/mol, for example a weight average molecular weight of about 10,000 g/mol to about 40,000 g/mol. When the modified acrylic copolymer (B) has a weight average molecular weight within the above ranges, degradation of the modified acrylic copolymer (B) during manufacture of the polycarbonate resin composition and/or a product formed thereof can be minimized, and the modified acrylic copolymer (B) can have excellent compatibility with the polycarbonate resin.

The polycarbonate resin composition can include the modified acrylic copolymer (B) in an amount of about 20 to about 40 wt. %, based on about 100 wt. % of a base resin composition comprising (A)+(B)+(C)+(D). In some embodiments, the polycarbonate resin composition can include the modified acrylic copolymer (B) in an amount of about 20, 21, 22, 23, 24, 25, 26, 27, 28, 29, 30, 31, 32, 33, 34, 35, 36, 37, 38, 39, or 40 wt. %. Further, according to some embodiments of the present invention, the amount of the modified acrylic copolymer (B) can be in a range from about any of the foregoing amounts to about any other of the foregoing amounts.

When the polycarbonate resin composition includes the modified acrylic copolymer (B) in an amount within the above range, the composition can have excellent dyeability, impact strength, and scratch resistance.

(C) Rubber Modified Aromatic Vinyl Graft Copolymer Resin

A rubber modified aromatic vinyl graft copolymer resin (C) useful in this invention can be prepared by graft copolymerizing an aromatic vinyl monomer and optionally a monomer copolymerizable therewith (such as a vinyl cyanide monomer) onto a rubber polymer.

Examples of the rubber polymer can include without limitation butadiene type rubbers, isoprene type rubbers, copolymers of butadiene and styrene, alkyl acrylate rubbers, and the like, and combinations thereof. In exemplary embodiments, polybutadiene can be used.

The rubber modified aromatic vinyl graft copolymer (C) can include rubber polymer in an amount of about 30 to about 70 wt. %, based on the total weight of the rubber modified graft copolymer (C). In some embodiments, the rubber modified aromatic vinyl graft copolymer (C) can include rubber polymer in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 wt. %. Further, according to some embodiments of the present invention, the amount of the rubber polymer can be in a range from about any of the foregoing amounts to about any other of the foregoing amounts.

The size of butadiene rubber particles can range from about 2,500 to about 3,500 A° at more than 90% level, and the gel content can be greater than about 50%.

Examples of the aromatic vinyl monomer that can be graft copolymerized with the rubber copolymer include without limitation styrene, C1 to C10 alkyl substituted styrene such as α-methylstyrene, halogen substituted styrene, and the like, and combinations thereof. As used herein, C1 to C10 alkyl substituted and/or halogen substituted styrene includes styrene in which a hydrogen atom of the benzene ring or the vinyl group is substituted with C1 to C10 alkyl and/or halogen. In exemplary embodiments, the aromatic vinyl monomer is styrene.

Examples of monomers that can be copolymerized with the aromatic vinyl monomer include without limitation vinyl cyanide monomers such as acrylonitrile, methacrylonitrile, and the like, and combinations thereof.

The rubber modified graft copolymer resin (C) can include aromatic vinyl monomers and other monomers copolymerizable therewith in an amount of about 30 to about 70 wt. %, based on the total weight of the rubber modified graft copolymer resin (C). In some embodiments, the rubber modified aromatic vinyl graft copolymer (C) can include aromatic vinyl monomers and other monomers copolymerizable therewith in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 wt. %. Further, according to some embodiments of the present invention, the amount of the aromatic vinyl monomers and other monomers copolymerizable therewith can be in a range from about any of the foregoing amounts to about any other of the foregoing amounts.

The graft rate of the rubber modified graft copolymer resin (C) can be about 50 to about 70%, and the rubber modified graft copolymer (C) can have a weight average molecular weight of about 50,000 to about 60,000.

An exemplary rubber modified aromatic vinyl graft copolymer resin (C) is acrylonitrile-butadiene-styrene graft copolymer (g-ABS).

The polycarbonate resin composition can include the rubber modified aromatic vinyl graft copolymer (C) in an amount of about 5 to about 10 wt. %, based on about 100 wt. % of a base resin composition comprising (A)+(B)+(C)+(D). In some embodiments, the polycarbonate resin composition can include the rubber modified aromatic vinyl graft copolymer (C) in an amount of about 5, 6, 7, 8, 9, or 10 wt. %. Further, according to some embodiments of the present invention, the amount of the rubber modified aromatic vinyl graft copolymer (C) can be in a range from about any of the foregoing amounts to about any other of the foregoing amounts.

(D) Polybutylene Terephthalate (PBT)

Polybutylene terephthalate (D) can provides excellent dimension stability due to its low moisture absorption property, and the combination of resins with PBT can exhibit exceptionally high hardness and heat resistance property.

The polybutylene terephthalate can be obtained via copolymerization of butanediol and terephthalic acid or dimethyl terephthalate. The polybutylene terephthalate can also include one or more additional dicarboxylic acids and/or diols. Examples of additional dicarboxylic acids include without limitation isophthalic acid, naphthalene dicarboxylic acid, diphenyl ether dicarboxylic acid, diphenyl dicarboxylic acid, diphenylsulfone dicarboxylic acid, and the like, and combinations thereof. Examples of additional diol components include without limitation polyethylene, α,ω-diols such as ethylene glycol, trimethylene glycol, tetramethylene glycol, hexamethylene glycol, neopentyl glycol, cyclohexane dimethylol, 2,2bis(4-β-(3-hydroxyphenyl-phenyl)-propane, 4,4-bis-(β-hydroxy epoxy)-diphenylsulfone, and diethylene glycol, the like, and combinations thereof.

The polycarbonate resin composition includes polybutylene terephthalate (D) in an amount of about 10 to about 30 wt. %, based on about 100 wt % of a base resin composition comprising (A)+(B)+(C)+(D). In some embodiments, the polycarbonate resin composition can include polybutylene terephthalate (D) in an amount of about 10, 11, 12, 13, 14, 15, 16, 17, 18, 19, 20, 21, 22, 23, 24, 25, 26, 27, 28, 29, or 30 wt. %. Further, according to some embodiments of the present invention, the amount of the polybutylene terephthalate (D) can be in a range from about any of the foregoing amounts to about any other of the foregoing amounts.

(E) Siloxane-Co-Polyester Copolymer

In this invention, siloxane-co-polyester copolymer (E) is a component which is added to the polycarbonate resin composition to improve resistance against minute scratches or scratches from routine use by improving the surface slip property of the resin with minimal or no decrease in other physical properties of the polycarbonate resin.

Generally, a separate slip agent is used to improve resin scratch resistance. The present inventors have found, however, that even if minute amounts of slip agents such as silicone oil and silicone gum are added, black impression of the resin is significantly impaired, which can deteriorate the quality of the appearance of the resulting formed product. When black impression impairment as noted above occurs, an additional coating process can be required, accompanied with post processing. This, however, can complicate the process, increase defects, decrease productivity, and limit recycling when the product is disposed.

The present inventors have found that if siloxane-co-polyester copolymer is added as a slip agent to the base resin composition including (A)+(B)+(C)+(D) discussed herein, changes to the physical properties of the base resin (for example, impact resistance) can be minimized and surface slip property and mar resistance can be improved. The composition further can maintains excellent black impression without additional coating or painting processes. Exemplary siloxane-co-polyester copolymers are known in the art and are commercially available.

In this invention, the polycarbonate resin composition can include siloxane-co-polyester copolymer (E) in an amount of about 1 to about 8 parts by weight, for example about 2 to about 5 parts by weight, based on about 100 parts by weight of the base resin composition comprising (A)+(B)+(C)+(D). In some embodiments, the polycarbonate resin composition can include siloxane-co-polyester copolymer (E) in an amount of about 1, 2, 3, 4, 5, 6, 7 or 8 parts by weight. Further, according to some embodiments of the present invention, the amount of the siloxane-co-polyester copolymer (E) can be in a range from about any of the foregoing amounts to about any other of the foregoing amounts.

When the polycarbonate resin composition includes the siloxane-co-polyester copolymer (E) in an amount within the above range, the composition can exhibit minimum slip property and excellent mar resistance on the resin surface. If the amount of siloxane-co-polyester copolymer (E) exceeds about 8 parts by weight, it can be difficult to process the composition to make an article due to high slippage, and black impression impairment can occur. If the amount of siloxane-co-polyester copolymer (E) is less than about 1 part by weight, sufficient mar resistance cannot be achieved.

The polycarbonate resin composition can additionally include one or more additives. Examples of additives include without limitation antimicrobial agents, thermo-stabilizers, antioxidants, release agents, light stabilizers, inorganic additives, surfactants, coupling agents, plasticizers, compatibilizers, lubricants, antistatic agents, coloring agents, pigments, dyes, flame retardants, auxiliary flame retardants, anti-dripping agents, weather resistance agents, UV absorbents, UV screening agents, and the like, and combinations thereof.

Examples of antioxidants include without limitation phenol type antioxidants, phosphite type antioxidants, thioester type antioxidants, amine type antioxidants, and the like, and combinations thereof.

Examples of releasing agents include without limitation fluoride containing polymers, silicone oils, metal salts of stearic acid, metal salts of montanic acid, montanic ester waxes, polyester waxes, and the like, and combinations thereof.

Examples of inorganic additives include without limitation glass fibers, carbon fibers, silica, mica, alumina, clay, calcium carbonate, calcium sulphate, glass beads, and the like, and combinations thereof.

Examples of pigments or dyes include without limitation titanium dioxide, carbon black, and the like, and combinations thereof. Examples of carbon black include without limitation graphitized carbon, furnace black, carbon black, and the like, and combinations thereof.

Examples of auxiliary flame retardants include without limitation antimony oxide and the like and combinations thereof.

Examples of anti-dripping agents include without limitation polytetrafluoroethylene and the like, and combinations thereof.

Examples of weather resistance agents include without limitation benzophenone type weather resistance agents, amine type weather resistance agents, and the like, and combinations thereof.

The above additives can be added in an amount of about 0.1 wt. % to about 40 wt. %, based on about 100 wt. % of a base resin composition comprising (A)+(B)+(C)+(D).

The polycarbonate resin composition of the invention can have a notch Izod impact strength (⅛″) of about 10 kgf·cm/cm to about 65 kgf·cm/cm measured in accordance with the method in ASTM D256.

Also the polycarbonate resin composition of the invention can have a heat deflection temperature of higher than about 100° C. measured in accordance with ASTM D648 which can be desirable in various applications.

The mar resistance of the polycarbonate resin composition of the invention can be measured as a function of gloss change after rubbing a 8×15 cm specimen with white cotton cloth measured using a gloss meter (M23888 from SDL ATLAS). Based on this test, the polycarbonate resin composition of the invention can have a mar resistance of ΔGloss (20²⁰) of less than about 15 which indicates excellent mar resistant property.

The polycarbonate resin composition of the invention can have a pencil hardness of higher than pencil hardness grade F measured under a 500 g load in accordance with the method specified in JIS K5401, which can provide excellent scratch resistance property.

The polycarbonate resin composition of the invention can be prepared using any conventional method for resin composition manufacturing. For example, the polycarbonate resin composition of the invention can be prepared in the form of pellets after combining composition components and other optionally additives and melt extruding the composition.

The polycarbonate resin composition of the invention can be used in the manufacture of non-coated molded products, and also can be used in the manufacture of molded products which require excellent dyeability, impact resistance, scratch resistance, and mar resistance at the same time. For example, the polycarbonate resin composition of the invention can be used in the manufacture of electrical/electronic products, home appliances, office automation products, housings for mobile phones, materials for automobiles, and the like.

There are no specific limitations on the process used to make products formed of the polycarbonate resin composition of the invention. Non-limiting examples of manufacturing processes include extrusion, injection molding, and casting. These and other suitable processes can be readily used by one of ordinary skill in the art.

This invention will be discussed in more detail in the following examples, but the examples are used only for purposes of exemplifying or illustrating this invention and are not intended to limit the scope of protection of this invention.

### EXAMPLES

Each compositional ingredient used in the examples as well as comparative examples are as below.

Polycarbonate Resin

(A) Bisphenol-a Type Linear Polycarbonate Resin PANLITE L-1250 from TEIJIN, Japan with a Weight Average Molecular Weight of 25,000 g/mol is Used.

(B) Modified Acrylic Copolymer Resin

A modified acrylic copolymer with a refractive index of 1.515 and a weight average molecular weight of 15,000 g/mol prepared by commonly applied suspension polymerization method using 30 wt. % phenyl methacrylate monomer with a refractive index of 1.570 and 70 wt. % methyl methacrylate monomer is used.

(C) g-ABS Resin

g-ABS resin commercially available from Cheil Industries Inc., Korea, including 58 wt. % butadiene rubber copolymer core and 42 wt. % of a shell, wherein the shell includes 31.5 wt. % of styrene and 10.5 wt. % of acrylonitrile, is used.

(D) Polybutylene Terephthalate Resin (PBT)
DHK011 with an intrinsic viscosity [η] of 1.2 dl/g commercially available from Shinkong is used.

(E) Siloxane-Co-Polyester
Tegomer H—Si 6440P commercially available from DEGUSA with a melting point of 54° C. and function group grade 1 is used.

(F) Polymethylmethacrylate (PMMA)
PM-7200 commercially available from Cheil Industries Inc., Korea, including methylmethacrylate with a weight average molecular weight of about 100,000 is used.

### Examples 1-3 and Comparative examples 1-8

After mixing the ingredients in the amounts indicated in Table 1 below, this mixture is extruded using a double axis extruder with a diameter of 45 mm, and the resulting extruded materials are prepared in the form of pellets. The prepared pellets are dried using a dehumidifier dryer at a temperature 100° C. for 4 hours, and then the pellets are injection molded to prepare test specimens for physical property measurements. Physical properties are measured for the prepared test specimens in accordance with the methods below and the results are presented in Table 1.
(1) Notch Izod impact strength: Impact strength for a test specimen with a thickness of ⅛″ is measured in accordance with the test method of ASTM D256.
(2) Heat deflection temperature (HDT): HDT is measured in accordance with the method specified in ASTM D648 (Unit: ° C.).
(3) Pencil hardness: Pencil hardness is measured with a 500 g load in accordance with the method specified in ASTM D3362.
(4) ΔGloss (20°): a specimen with a size of 8×15 cm is rubbed with a white cotton cloth and ΔGloss (20°) (the change in value of 20°) is measured using a gloss meter (M23888 from SDL ATLAS) as specified in ASTM D523. Since larger changes in ΔGloss values generally indicate more sever marring, generally smaller ΔGloss values indicate excellent mar resistant property.
(5) Moldability: the test specimen prepared via an injection molding process are examined by the naked eye to determine the presence of defects (Good: O, defect: X)

TABLE 1

| | Implementation | | | | | | | | | | |
|---|---|---|---|---|---|---|---|---|---|---|---|
| | examples | | | Comparison examples | | | | | | | |
| | 1 | 2 | 3 | 1 | 2 | 3 | 4 | 5 | 6 | 7 | 8 |
| Polycarbonate resin (A) | 45 | 35 | 35 | 75 | — | 45 | 45 | 45 | 45 | 63 | 45 |
| Modified acryl copolymer | 30 | 40 | 30 | — | 75 | 30 | 45 | 30 | — | 30 | 30 |
| (B) | | | | | | | | | | | |
| g-ABS (C) | 7 | 7 | 7 | 7 | 7 | — | 7 | 10 | 7 | 7 | 7 |
| PBT (D) | 15 | 15 | 25 | 15 | 15 | 25 | — | 18 | 15 | — | 15 |
| Siloxane-co-Polyester (E) | 3 | 3 | 3 | 3 | 3 | 3 | 3 | — | 3 | — | 10 |
| PMMA (F) | — | — | — | — | — | — | — | — | 30 | — | — |
| Izod impact strength (⅛″, | 20 | 10 | 10 | 60 | 3 | 5 | 8 | 25 | 4 | 15 | 10 |
| kg · cm/cm) | | | | | | | | | | | |
| HDT (° C.) | 105 | 100 | 102 | 120 | 85 | 108 | 98 | 106 | 100 | 106 | 92 |
| Pencil hardness | F | H | F | 2B | 2H | F | H | HB | F | F | F |
| ΔGloss (20°) | 5.3 | 6.7 | 1.3 | 4.6 | 16.5 | 3.3 | 20.5 | 25.1 | 5.3 | 40.8 | 1.0 |
| Moldability | ◯ | ◯ | ◯ | ◯ | ◯ | ◯ | ◯ | ◯ | ◯ | ◯ | X |

As can be seen in the above Table 1, examples 1-3 including both polybutylene terephthalate (D) and siloxane-co-polyester (E) have excellent impact resistance, heat deflection temperature, scratch resistance (pencil hardness), and mar resistance.

Comparative example 1 does not include modified acrylic copolymer (B) and exhibits decreased scratch resistance.

Comparative example 2 does not include polycarbonate resin (A) and also includes modified acrylic copolymer (B) in an amount greater than the claimed invention and exhibits significantly decreased impact resistance and decreased mar resistance.

Comparative example 3 does not include ABS resin (C) and exhibits decreased impact resistance.

Comparative example 4 does not include PBT (D) and exhibits decreased impact strength and heat resistance, and in addition mar resistance is significantly decreased.

Comparative example 5 does not include siloxane-co-polyester (E) and exhibits significantly decreased mar resistance.

In comparative example 6, high molecular weight PMMA (A) is used instead of the modified acrylic copolymer (B). It is believed that the high molecular weight PMMA and low level of polycarbonate resin results in reduced compatibility and impact resistance is significantly decreased.

Comparative example 7 without both the PBT (D) and siloxane-co-polyester (E) exhibits a significant decrease in mar resistance.

Comparative example 8 includes an excessive amount of siloxane-co-polyester (E) (10 parts) and exhibits poor moldability as confirmed by the naked eye.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

1. A polycarbonate resin composition comprising:
(A) polycarbonate resin;
(B) modified acrylic copolymer;
(C) rubber modified aromatic vinyl graft copolymer;
(D) polybutylene terephthalate resin; and
(E) siloxane-co-polyester.

2. The polycarbonate resin composition of claim 1, comprising:
a base resin comprising about 30 to about 50 wt. % of said polycarbonate resin (A);
about 20 to about 40 wt. % of said modified acrylic copolymer (B); about 5 to about 10 wt. % of said rubber modified aromatic vinyl graft copolymer (C); and about 10 to about 30 wt. % of said polybutylene terephthalate resin (D); and
about 1 to about 8 parts by weight of said siloxane-co-polyester (E), based on about 100 parts by weight of the base resin composition including (A)+(B)+(C)+(D).

3. The polycarbonate resin composition of claim 1, wherein said modified acrylic copolymer (B) includes a unit derived from acrylate or methacryate including an aliphatic cyclic hydrocarbon group or an aromatic hydrocarbon group.

4. The polycarbonate resin composition of claim 1, wherein said modified acrylic copolymer (B) is a copolymer of an acrylate or methacrylate including an aliphatic cyclic hydrocarbon group or an aromatic hydrocarbon group, and (b2) a mono-functional unsaturated monomer.

5. The polycarbonate resin composition of claim 4, wherein said modified acrylic copolymer (B) includes about 5 to about 95 wt. % of said acrylate or methacrylate (b1) including an aliphatic cyclic hydrocarbon group or an aromatic hydrocarbon group and about 5 to about 95 wt. % of said mono-functional unsaturated monomer (b2).

6. The polycarbonate resin composition of claim 3, wherein said acrylate or methacrylate (b1) including an aliphatic cyclic hydrocarbon group or an aromatic hydrocarbon group is represented by the following Chemical Formula 2, Chemical Formula 3, or a combination thereof: 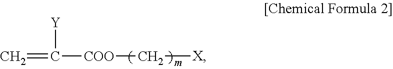
wherein the above Chemical Formula 2:
m is an integer of 0 to 10;
X is C3 to C30 cycloalkyl, C3 to C30 cycloalkenyl, C3 to C30 cycloalkynyl, or C6 to C30 aryl; and
Y is hydrogen or methyl; 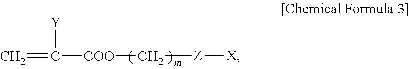
wherein the above Chemical Formula 3:
m is an integer of 0 to 10;
X is C3 to C30 cycloalkyl, C3 to C30 cycloalkenyl, C3 to C30 cycloalkynyl, or C6 to C30 aryl;
Y is hydrogen or methyl; and
Z is O or S.

7. The polycarbonate resin composition of claim 3, wherein said acrylate or methacrylate (b1) including an aliphatic cyclic hydrocarbon group or an aromatic hydrocarbon group comprises cyclohexyl acrylate, cyclohexyl methacrylate, ethylphenoxy acrylate, ethylphenoxy methacrylate, 2-ethylthiophenyl acrylate, 2-ethylthiophenyl methacrylate, 2-ethylaminophenyl acrylate, 2-ethylaminophenyl methacrylate, phenyl acrylate, phenyl methacrylate, benzyl acrylate, benzyl methacrylate, 2-phenylethyl acrylate, 2-phenylethyl methacrylate, 3-phenylpropyl acrylate, 3-phenylpropyl methacrylate, 4-phenylbutyl acrylate, 4-phenylbutyl methacrylate, 2-2-methylphenylethyl acrylate, 2-2-methylphenylethyl methacrylate, 2-3-methylphenylethyl acrylate, 2-3-methylphenylethyl methacrylate, 2,4-methylphenylethyl acrylate, 2,4-methylphenylethyl methacrylate, 2-(4-propylphenyl)ethyl acrylate, 2-(4-propylphenyl)ethyl methacrylate, 2-(4-(1-methylethyl)phenyl)ethyl acrylate, 2-(4-(1-methylethyl)phenyl)ethyl methacrylate, 2-(4-methoxyphenyl)ethyl acrylate, 2-(4-methoxyphenyl)ethyl methacrylate, 2-(4-cyclohexylphenyl)ethyl acrylate, 2-(4-cyclohexylphenyl)ethyl methacrylate, 2-(2-chlorophenyl)ethyl acrylate, 2-(2-chlorophenyl)ethyl methacrylate, 2-(3-chlorophenyl)ethyl acrylate, 2-(3-chlorophenyl)ethyl acrylate methacrylate, 2-(4-chlorophenyl)ethyl acrylate, 2-(4-chlorophenyl)ethyl metahcrylate, 2-(4-bromophenyl)ethyl acrylate, 2-(4-bromophenyl)ethyl methacrylate, 2-(3-phenylphenyl)ethyl acrylate, 2-(3-phenylphenyl)ethyl methacrylate, 2-(4-benzylphenyl)ethyl acrylate, 2-(4-benzylphenyl)ethyl methacrylate, and combinations thereof.

8. The polycarbonate resin composition of claim 4, wherein said mono-functional unsaturated monomer (b2) comprises an acrylate or methacrylate comprising an aliphatic non-cyclic hydrocarbon group, unsaturated carboxylic acid, unsaturated carboxylic anhydride, unsaturated monomer comprising an hydroxy group, unsaturated monomer containing an epoxy group, unsaturated amide monomer, unsaturated imide monomer, unsaturated nitrile monomer, aromatic vinyl monomer, or a combination thereof.

9. The polycarbonate resin composition of claim 1, wherein said modified acrylic copolymer (B) has a refractive index of about 1.495 to about 1.590.

10. The polycarbonate resin composition of claim 1, wherein said modified acrylic copolymer (B) has a weight average molecular weight of about 5,000 g/mol to about 50,000 g/mol.

11. The polycarbonate resin composition of claim 1, wherein said rubber modified aromatic vinyl graft copolymer is acrylonitrile-butadiene-styrene graft copolymer (g-ABS).

12. The polycarbonate resin composition of claim 11, wherein the g-ABS copolymer is a product of about 30 to about 70 wt. % of a monomer mixture of vinyl cyanide compound and aromatic vinyl compound suspension graft polymerized in the presence of about 30 to about 70 wt. % of rubber copolymer.

13. The polycarbonate resin composition of claim 1, further comprising an additive comprising an antimicrobial agent, thermo-stabilizer, antioxidant, release agent, light stabilizer, inorganic additive, surfactant, coupling agent, plasticizer, compatibilizer, lubricant, antistatic agent, coloring agent, pigment, dye, flame retardant, auxiliary flame retardant, anti-dripping agent, weather resistance agent, UV absorbent, UV screening agent, or a combination thereof.

14. The polycarbonate resin composition of claim 1, having a notch Izod impact strength of about 10 kgf·cm/cm to about 65 kgf·cm/cm measured in accordance with ASTM D256.

15. The polycarbonate resin composition of claim 1, having a heat deflection temperature of about 100° C. to about 150° C. measured in accordance with ASTM D648.

16. The polycarbonate resin composition of claim 1, having a ΔGloss (20°) of less than about 15 measured using a gloss meter (M23888 from SDL ATLAS) in accordance with ASTM D523 after rubbing a 8×15 sized specimen with white cotton cloth ten times.

17. The polycarbonate resin composition of claim 1, having a pencil hardness higher than pencil hardness grade F measured in accordance with JIS K5401 under a load of 500 g.
